(19) United States
(12) Patent Application Publication
(10) Pub. No.: US 2022/0101134 A1
(43) Pub. Date: Mar. 31, 2022

(54) DEEP NEURAL NETWORK TRAINING METHOD AND SYSTEM, AND CAUSALITY DISCOVERY METHOD

(71) Applicant: ELECTRONICS AND TELECOMMUNICATIONS RESEARCH INSTITUTE, Daejeon (KR)

(72) Inventor: Yong Jin LEE, Daejeon (KR)

(73) Assignee: ELECTRONICS AND TELECOMMUNICATIONS RESEARCH INSTITUTE, Daejeon (KR)

(21) Appl. No.: 17/488,812

(22) Filed: Sep. 29, 2021

(30) Foreign Application Priority Data
Sep. 29, 2020 (KR) 10-2020-0126877

(51) Int. Cl. G06N 3/08; G06N 3/04; G06K 9/62

(52) U.S. Cl. CPC G06N 3/08; G06N 3/0481; G06K 9/6296; G06K 9/6215; G06K 9/6202

(57) ABSTRACT

Provided is a deep neural network training method for detecting causality between input values. The method includes inputting an input value of training data acquired from n input variables to an input layer of a first neural network, which is based on a graph neural network, and calculating a predicted value through an output layer; training the first neural network on the basis of first training information, which is a result of comparing the predicted value to a target value of the training data; receiving an intermediate value in an l^{th} hidden layer (l is a natural number greater than or equal to 1) of the first neural network from a second neural network, which is based on a deep neural network, and calculating an intermediate point value between a point at which the input value is observed and a point at which the target value is observed; and training the first and second neural networks on the basis of second training information based on similarity between the intermediate point value and the input value of the training data.

### CROSS-REFERENCE TO RELATED APPLICATION

This application claims priority to and the benefit of Korean Patent Application No. 2020-0126877 filed on Sep. 29, 2020, the disclosure of which is incorporated herein by reference in its entirety.

### BACKGROUND

### 1. Field of the Invention

The present invention relates to a deep neural network training method and system and a causality discovery method and, more particularly, to a deep neural network training method and system for discovering the causality between input variables.

### 2. Discussion of Related Art

In general, as a process for preparing evidence for an effective analysis of the cause and effect of an event, various studies have been conducted on causality relationship estimation. This can be used in various fields such as system error analysis and traffic condition information.

Among various causality relationship analysis methods, the Granger causality analysis method is a widely used analysis method for causality relationship analysis on time series data. The Granger causality analysis method, which is a linear method, has disadvantages in that it is difficult to apply the analysis method in a non-linear variable environment and in that it is difficult to analyze a causality relationship between input variables in an environment having many variables.

Also, in order to analyze the causality relationship between input variables, applying a neural network technique may be considered. However, while a deep neural network has excellent prediction and recognition performance, it is difficult for the deep neural network to interpret its inference results. Also, even when a graph neural network is applied, a user has to input all relationships between many input variables.

Therefore, in an environment having many input variables, there is a need for a technology that can automatically derive relationships between the input variables from training data and facilitate the interpretation of training results of a deep neural network on the basis of the relationships.

### SUMMARY OF THE INVENTION

Embodiments of the present invention provide a deep neural network training method and system capable of automatically extracting a causality relationship between input variables from training data through a training process by combining graph neural network technology and deep neural network technology, and a causality detection method thereof.

However, technical objects to be achieved by the present embodiments are not limited to the above-mentioned technical objects, and other technical objects may be present.

According to a first aspect of the present invention, there is provided a deep neural network training method for detecting causality between input values, the deep neural network training method including inputting an input value of training data acquired from n input variables (n is a natural number greater than or equal to two) to an input layer of a first neural network, which is based on a graph neural network, and calculating a predicted value through an output layer, training the first neural network on the basis of first training information, which is a result of comparing the predicted value to a target value of the training data, receiving an intermediate value in an l^{th} hidden layer (l is a natural number greater than or equal to one) of the first neural network from a second neural network, which is based on a deep neural network, and calculating an intermediate point value between a point at which the input value is observed and a point at which the target value is observed, and training the first and second neural networks on the basis of second training information based on similarity between the intermediate point value and the input value of the training data.

Also, according to a second aspect of the present invention, there is provided a method of detecting causality between input variables using a deep neural network, the method including inputting an input value of training data acquired from n input variables (n is a natural number greater than or equal to 2) to an input layer of a first neural network, which is based on a graph neural network, and calculating a predicted value through an output layer, training the first neural network on the basis of first training information, which is a result of comparing the predicted value to a target value of the training data, receiving an intermediate value in an l^{th} hidden layer (l is a natural number greater than or equal to 1) of the first neural network from a second neural network, which is based on a deep neural network, and calculating an intermediate point value between a point at which the input value is observed and a point at which the target value is observed, training the first and second neural networks on the basis of second training information based on similarity between the intermediate point value and the input value of the training data, repeatedly training the first and second neural networks a preset maximum number of training times, and providing an adjacency matrix of the trained first neural network. In this case, the adjacency matrix is characterized by having a size corresponding to the square of the number (n) of input variables and an element value with causality between 0 and 1, which is relatively expressed according to the strength of the causality relationship between the input variables.

Also, according to a third aspect of the present invention, there is provided a deep neural network-based system for detecting causality between input values, the deep neural network-based system including a memory in which a program for detecting the causality between the input values on the basis of training data acquired from n input variables (n is a natural number greater than or equal to 2) is stored and a processor configured to execute the program stored in the memory. In this case, when the program is executed, the processor inputs an input value of training data to an input layer of a first neural network, which is based on a graph neural network, calculates a predicted value through an output layer, and trains the first neural network on the basis of first training information, which is a result of comparing the predicted value to a target value of the training data, and the processor receives an intermediate value in an l^{th} hidden layer (l is a natural number greater than or equal to 1) of the first neural network from a second neural network, which is based on a deep neural network, calculates an intermediate point value between a point at which the input value is observed and a point at which the target value is observed, and trains the first and second neural networks on the basis of second training information based on similarity between the intermediate point value and the input value of the training data.

In addition, there may be further provided other methods and systems for implementing the present invention and a computer-readable recording medium in which a computer program for executing the methods is recorded.

### BRIEF DESCRIPTION OF THE DRAWINGS

FIG. 1 is a block diagram of a deep neural network system according to an embodiment of the present invention.

FIG. 2 is a diagram illustrating the function of a deep neural network system according to an embodiment of the present invention.

FIG. 3 is a diagram illustrating training data collected from an input variable.

FIG. 4 is a diagram illustrating a flow of information corresponding to the input of training data.

FIG. 5 is a diagram illustrating a flow of first training information and second training information.

FIG. 6 is a diagram schematically illustrating a hidden layer of a first neural network.

FIGS. 7A and 7B are diagrams illustrating a hidden layer of a first neural network.

FIG. 8 is a flowchart of a deep neural network training method according to an embodiment of the present invention.

### DETAILED DESCRIPTION OF EXEMPLARY EMBODIMENTS

Advantages and features of the present invention, and implementation methods thereof will be clarified through the following embodiments described in detail with reference to the accompanying drawings. However, the present invention is not limited to embodiments disclosed herein and may be implemented in various different forms. The embodiments are provided for making the disclosure of the present invention thorough and for fully conveying the scope of the present invention to those skilled in the art. It is to be noted that the scope of the present invention is defined by the claims.

The terminology used herein is for the purpose of describing particular embodiments only and is not intended to be limiting to the invention. Herein, the singular shall be construed to include the plural, unless the context clearly indicates otherwise. The terms “comprises” and/or “comprising” used herein specify the presence of stated elements but do not preclude the presence or addition of one or more other elements. Like reference numerals refer to like elements throughout the specification, and the term “and/or” includes any and all combinations of one or more of the associated listed items. It will be also understood that, although the terms first, second, etc. may be used herein to describe various elements, these elements should not be limited by these terms. These terms are only used to distinguish one element from another. Thus, a first element could be termed a second element without departing from the technical spirit of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

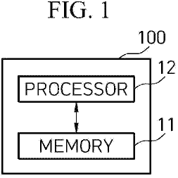

A deep neural network-based system (hereinafter referred to as a deep neural network system) 100 for discovering the causality between input variables according to an embodiment of the present invention will be described below with reference to FIGS. 1 to 7.

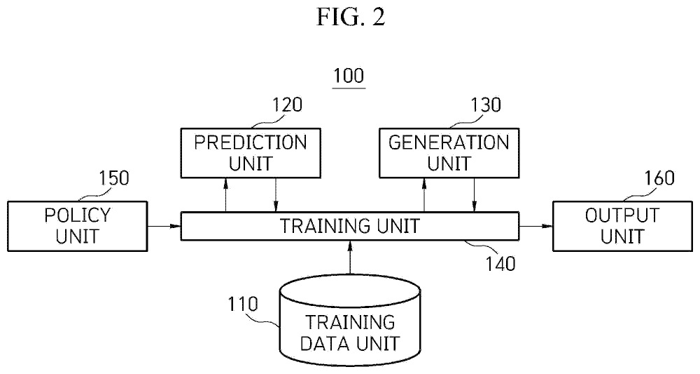

FIG. 1 is a block diagram of the deep neural network system 100 according to an embodiment of the present invention. FIG. 2 is a diagram illustrating the function of the deep neural network system 100 according to an embodiment of the present invention.

The deep neural network system 100 according to an embodiment of the present invention includes a memory 11 and a processor 12.

A program for discovering the causality between input values on the basis of training data acquired from n input variables is stored in the memory 11, and the processor 12 is configured to execute the program stored in the memory 11.

In this case, the memory 11 collectively refers to a non-volatile storage device, which maintains stored information even when no power is supplied, and a volatile storage device. For example, the memory 11 may include a NAND flash memory such as a compact flash (CF) card, a secure digital (SD) card, a memory stick, a solid-state drive (SSD), or a micro SD card, a magnetic computer memory device such as a hard disk drive (HDD), and an optical disc drive such as a compact disc (CD) read-only memory (ROM) or a digital versatile disc (DVD) ROM.

When the program stored in the memory 11 is executed, the processor 12 inputs an input value of the training data to a first neural network, calculates a predicted value, and trains a first neural network on the basis of first training information which is a result of comparing the predicted value and a target value of the training data.

Also, the processor 12 receives an intermediate value in the hidden layer of the first neural network from a second neural network, calculates an intermediate point value between the input value and the target value, and trains the first and second neural networks on the basis of second training information on the basis of similarity between the intermediate time value and the input value of the training data.

In this case, according to an embodiment of the present invention, the first neural network may be a graph neural network, and the second neural network may be a general deep neural network. The present invention has an advantage in that, by applying a graph neural network, it is possible to perform analysis for an input variable having a non-linear causality relationship and to automatically derive a causality relationship between multiple input variables from training data. In addition, by using a deep neural network in combination, it is possible to facilitate the interpretation of an inference result of the causality relationship of input variables.

FIG. 2 is a diagram illustrating functions performed by the memory 11 and the processor 12, and according to an embodiment of the present invention, a training data unit 110, a prediction unit 120, a generation unit 130, a training unit 140, a policy unit 150, and an output unit 160 are included.

The training data unit 110 stores training data acquired from n input variables (here n is a natural number greater than or equal to 2). In an embodiment, the training data includes an input value and a target value and is used to train the prediction unit 120 and the generation unit 130.

The prediction unit 120 may include a graph neural network, which is the first neural network, and the graph neural network includes an input layer, at least one hidden layer, and an output layer. The prediction unit 120 calculates a predicted value that is predicted from the input value of the training data acquired from n input variables.

The generation unit 130 may include a deep neural network, which is the second neural network, and the number of deep neural networks may correspond to the number of hidden layers included in the first neural network. The generation unit 130 receives a calculated intermediate value from the hidden layer of the first neural network, which is the prediction unit 120, and calculates an intermediate point value between a time point at which the input value is observed and a time point at which the target value is observed. In this case, the second neural network may include a neural network different from that of the first neural network. Meanwhile, a conventional deep neural network technique may be applied to the second neural network.

The training unit 140 includes a data input unit and an evaluation unit, the data input unit includes a predicted data input unit 141 and a generated data input unit 143, and the evaluation unit includes a prediction evaluation unit 142 and a generation evaluation unit 144. The training unit 140 trains the prediction unit 120 and the generation unit 130 using training data according to a condition set by the policy unit 150, which will be described below.

The policy unit 150 may set matters necessary for the training of the prediction unit 120 and the generation unit 130. For example, the policy unit 150 may perform settings for training end conditions for the training unit 140, hyper-parameters for the prediction unit 120 and the generation unit 130, etc. Also, the policy unit 150 may determine how to configure training data for the prediction unit 120 and the training unit 140.

When the training process by the training unit 140 ends, the output unit 160 outputs or stores a result of the training process. The output result according to an embodiment of the present invention may be the trained first and second neural networks. Alternatively, the output result may be an adjacency matrix of the first neural network. Alternatively, the training result may be processed after being provided to facilitate a user's understanding.

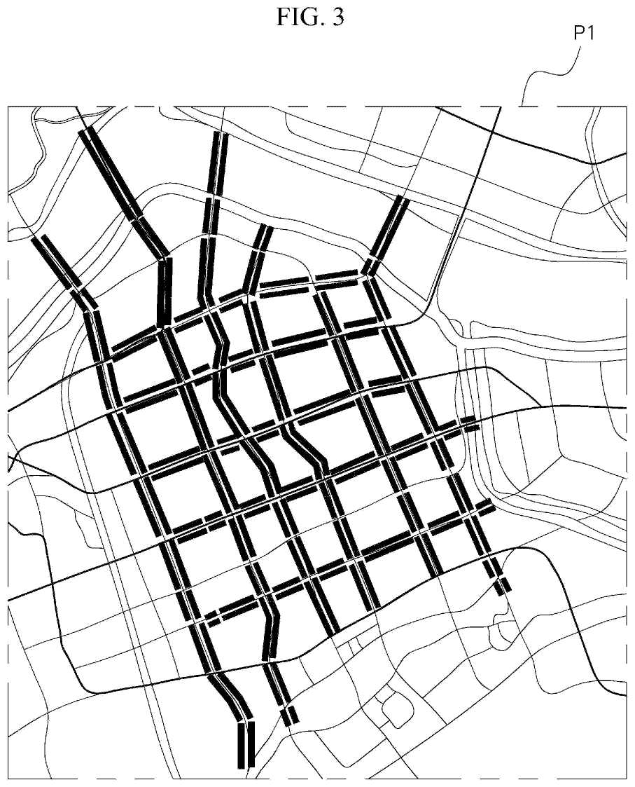

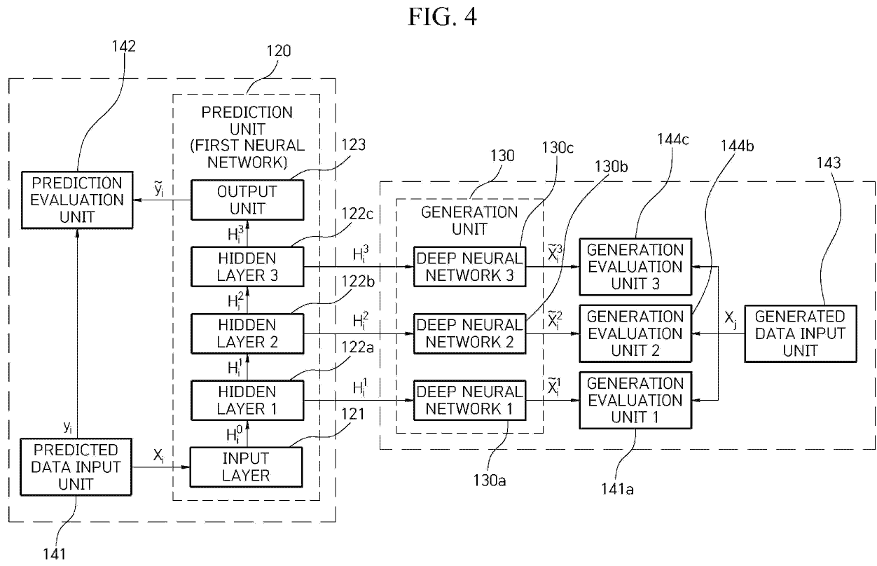

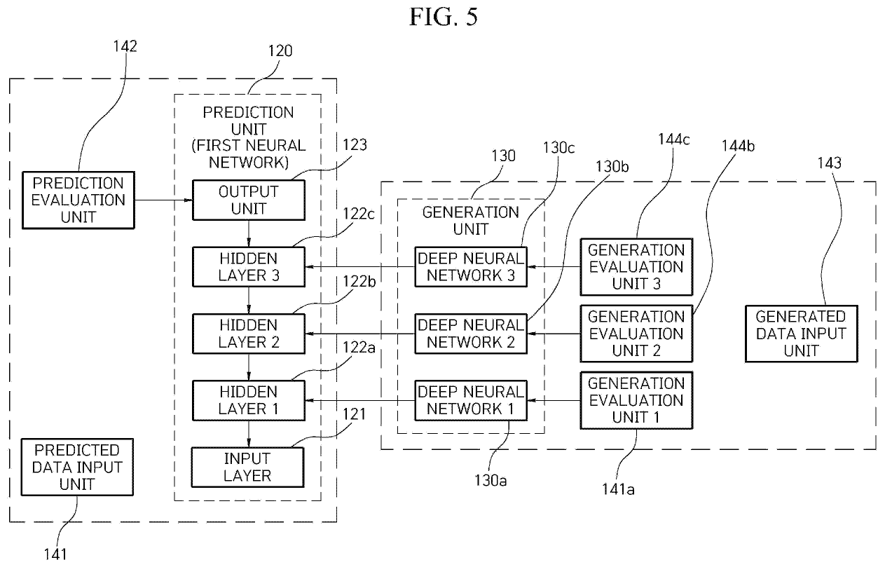

FIG. 3 is a diagram illustrating training data collected from an input variable. FIG. 4 is a diagram illustrating a flow of information corresponding to the input of training data. FIG. 5 is a diagram illustrating a flow of first training information and second training information.

In an embodiment, the training data includes an input value and a target value and is acquired from n input variables. In this case, the input variable refers to an input source and may include n sensors or n nodes. An embodiment of the present invention aims to derive the causality between n input variables when it is assumed that there are such n input variables.

An example of FIG. 3 includes a total of 170 roads and may be viewed as a graph including 170 nodes. That is, in FIG. 3, n is 170, and the training data acquired from n input variables becomes traffic state information of each road, such as vehicle speed or volume observed in the corresponding road.

The input value is state information observed in the past, and the target value is state information measured after the input value is observed. That is, the training data may include an input value observed at time t and a target value observed at time t+1 immediately after time t. Meanwhile, it is assumed that an intermediate point value between the input value and the target value is not directly observed from a node or a sensor, and the intermediate point value may be calculated through the second neural network which will be described below. However, embodiments of the present invention are not necessarily limited to the above assumption.

As described above, the present invention aims to accurately predict a target value from an input value through a graph neural network, perform training through a deep neural network such that an intermediate point value between the input value and the target value is generated similar to actual data at the same time, and thus find a causality relationship between input variables.

Since an example of a road network of FIG. 3 is actually already known, it is not very practical to use the road network as training data to find a connection structure thereof. This is just an example, and by extending this concept, it is possible to derive the relationship between the input variables from data observed over time. This may be used to derive interactions between protein molecular structures or the interconnection between parts included in a very complex machine.

FIG. 4 illustrates a flow of information generated from training data input to the predicted data input unit 141 and a generated data input unit 143. The corresponding information finally arrives at the prediction evaluation unit 142 and the generation evaluation unit 144 and is used to generate first and second training information for training the first neural network included in the prediction unit 120 and the second neural network included in the generation unit 130. Meanwhile, three hidden layers 122 of the first neural network are shown in FIG. 4 and subsequent drawings. However, the present invention is not limited thereto, and it will be appreciated that the design can be freely changed according to the purpose of implementation.

Specifically, the predicted data input unit 141 extracts training data acquired from n input variables from the training data unit 110. In this case, the training data includes an input value xᵢ and a target value yᵢ which are n-dimensional vectors. The predicted data input unit 141 delivers the input value xᵢ to the input layer 121 of the prediction unit 120 and delivers the target value yᵢ to the prediction evaluation unit 142.

The prediction unit 120 may include a graph neural network, and the graph neural network includes the input layer 121, the hidden layer 122, and the output layer 123.

The prediction unit 120 primarily aims to accurately predict the target value yᵢ on the basis of the input value xᵢ. When the input value xᵢ is delivered from the predicted data input unit 141, the prediction unit 120 outputs a predicted value \tilde{y}ᵢ obtained by predicting the target value yᵢ through the input layer 121, the hidden layer 122, and the output layer 123. The prediction unit 120 delivers the output predicted value \tilde{y}ᵢ to the prediction evaluation unit 142.

The prediction evaluation unit 142 generates first training information, which is a result of comparing the predicted value \tilde{y}ᵢ to the target value yᵢ of the training data, and trains the first neural network on the basis of the first training information. In an embodiment, the prediction evaluation unit 142 may generate the first training information on the basis of an error between the predicted value \tilde{y}ᵢ and the target value yᵢ. As an example, when the training data is time series data, an absolute error as in Equation 1 or a square root error as in Equation 2 may be used as the error.

$$\begin{matrix}{\sum }_{k = 1}^{n} \vert {y}_{i , k} - {\tilde{y}}_{i , k} \vert & [ Equation 1 ] \\ {\sum }_{k = 1}^{n} ( {y}_{i , k} - {\tilde{y}}_{i , k} ) & [ Equation 2 ]\end{matrix}$$

The graph neural network included in the prediction unit 120 will be described in more detail below.

In an embodiment of the present invention, the input layer 121 of the graph neural network is configured to receive n input values generated from n input variables. That is, the input layer 121 should be configured to process n input variables, and there are no other restrictions. As an example, the input layer 121 may be configured as a convolution or fully connected (FCN) layer that is typically used in a deep neural network, and the present invention is not limited to special structures.

In an embodiment of the present invention, the output layer 123 of the graph neural network outputs n predicted values corresponding to the n input values. As an example, the output layer 123 may be configured as a convolution or FCN layer that is typically used in a deep neural network, and the present invention is not limited to special structures.

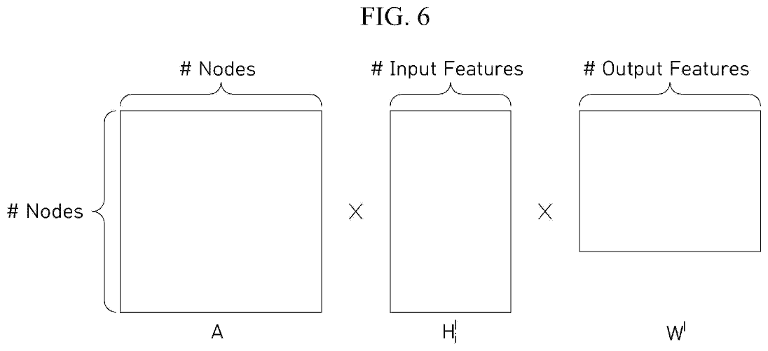

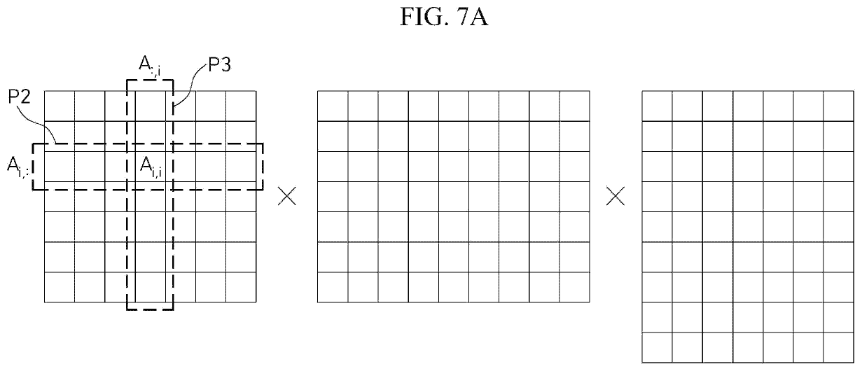

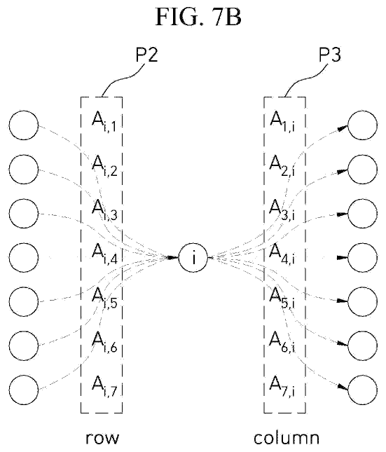

The hidden layer 122 in the prediction unit 120 is as shown in Equation 3 and FIG. 6. FIG. 6 is a diagram schematically illustrating a hidden layer 122 of a first neural network. FIGS. 7A and 7B are diagrams illustrating the hidden layer 122 of the first neural network.

Hᵢ^{l}=F(AHᵢ^{l-1}W^{l}) [Equation 3]

The first neural network of the prediction unit 120 includes at least one hidden layer 122, and an intermediate value in an l^{th} hidden layer (here, l is a natural number greater than or equal to one) is calculated based on an activation function in the l^{th} hidden layer. In this case, the activation function includes an adjacency matrix containing the causality between n input variables, model parameters, and an intermediate value in the (l−1)^{th} hidden layer.

Specifically, an input to the l^{th} hidden layer generated by the input value xᵢ is denoted as Hᵢ^{l-1}, and an output of the l^{th} hidden layer or an input to the l^{th} hidden layer is denoted as Hᵢ^{l}. Therefore, Hᵢ⁰ denotes the output value of the input layer.

The meaning of Hᵢ^{l} in FIG. 3 is described as follows. Hᵢ^{l} denotes state information (i.e., an intermediate value) of nodes at any point between a point at which the input value xᵢ is observed and a point at which the target value yᵢ is observed. This state information is not a value measured from an actual sensor or node like the input value xᵢ or the target value yᵢ but a value computed in consideration of mutual causality between nodes described in the adjacency matrix.

A denotes an adjacency matrix, and W^{l} denotes a model parameter. Also, F denotes any activation function. In an embodiment of the present invention, the adjacency matrix A and the model parameter W^{l} are finally determined through training. In this case, according to an embodiment of the present invention, several hidden layers 122 included in the first neural network may share the same matrix A.

Referring to FIG. 6, when the number of input variables is n, the adjacency matrix has a size of n×n corresponding to the square of the number (n) of input variables. In this case, values of the elements of the adjacency matrix A (here, element values) represent the causality between nodes or input variables. As an example, when the value of an element (i, j) of the adjacency matrix A is 0, this means that an i^{th} node is not directly affected by a j^{th} node. When the road network of FIG. 3 is described as an example, the traffic condition of an i^{th} road is not directly affected by a j^{th} road. Accordingly, the adjacency matrix is configured to have an element value with causality between 0 and 1, which is relatively expressed according to the strength of the causality relationship between the input variables.

FIGS. 7A and 7B explicitly shows how interrelationships between input variables are applied to the structure of the graph neural network, and an i^{th} row P2 of the adjacency matrix A indicates how much the i^{th} node is affected by other nodes, and an i^{th} column P3 of A indicates how much the i^{th} node affects other nodes.

Typically, an expert with domain knowledge about data should directly derive the adjacency matrix of the graph neural network by determining relevance (causality) between nodes. In contrast, an embodiment of the present invention aims at automatically deriving an adjacency matrix using training data such that the causality between nodes is well represented.

In an embodiment of the present invention, the adjacency matrix A may be constructed as follows.

First, the adjacency matrix A may be constructed such that a corresponding element value of the adjacency matrix A increases as the strength of the interaction or causality relationship between two specific nodes increases. In this case, there is an advantage in that a user can intuitively and more easily interpret the causality between nodes which is derived through training.

Also, the adjacency matrix A may be constructed such that when the influence of a specific node is large, the influence of other nodes is relatively small. This case is more useful in deriving a few major related nodes.

In addition, the adjacency matrix A may be constructed such that when two specific nodes have no relevance, the element value is 0. Thus, advantageously, it is easier to exclude unrelated nodes, and it is possible for a user to intuitively and easily interpret causality derived through training.

In consideration of this point, in an embodiment of the present invention, the adjacency matrix A may be constructed as follows.

First, each element value of the initial adjacency matrix Ã having the same size (number of elements) as the adjacency matrix A is calculated. An (i,j)^{th} element \tilde{γ}_{i,j} of the initial adjacency matrix Ã is defined as Equation 4 below.

γ_{i,j}=exp(α_{i,j})

\tilde{γ}_{i,j}=(γ_{i,j}−σ(βᵢ)∥γ_{i,:}∥₁−σ(βⱼ)∥γ_{:,j}∥₁)₊ [Equation 4]

In Equation 4, α_{i,j} and βⱼ are free independent scalar variables whose values are determined through training. σ(⋅) denotes a sigmoid function, and (⋅)₊ is defined as max(⋅, 0) and is processed as 0 when an input value is negative.

In Equation 4, ∥γ_{i,:}∥₁ and ∥γ_{:,j}∥₁ are defined as Equation 5 below.

$${‖ {γ}_{i , \text{:}} ‖}_{1} = {\sum }_{j = 1}^{n} {γ}_{i , j} , {‖ {γ}_{\text{:} , j} ‖}_{1} = {\sum }_{i = 1}^{n} {γ}_{i , j} \qquad [ Equation 5 ]$$

When the initial adjacency matrix Ã is defined based on Equations 4 and 5, the adjacency matrix A may be generated through the following iteration.

A=Ã

For k=1:N

[Dᵣ]ᵢ=ΣⱼA_{i,j} and [D_{c}]ⱼ=ΣᵢA_{i,j}

A=Dᵣ^{-1/2}AD_{c}^{-1/2}

A first diagonal matrix Dᵣ that sums element values in each row in the initial adjacency matrix Ã, and a second diagonal matrix D_{c} that sums element values in each column are generated. Also, the adjacency matrix A may be calculated based on a multiplication operation between the initial adjacency matrix Ã and a square root inverse matrix corresponding to the first diagonal matrix Dᵣ and the second diagonal matrix D_{c}. The above iteration gives the matrix the same effect as when softmax is applied to a vector.

According to the above iteration, the sum of the element values in each row and column of the adjacency matrix A is approximated to 1, which has the advantage of facilitating interpretation by a user. Also, when a specific element value increases, other related element values decrease, which is efficient in deriving relevance between nodes.

In addition, according to an embodiment of the present invention, a regularization term that targets each row and column of the adjacency matrix A may be set in the adjacency matrix A to increase the deviation between the element values included in the adjacency matrix A.

That is, according to the present invention, in addition to the prediction error as in Equation 1 or Equation 2 described above, a regularization term as shown in Equation 6 can be set in the adjacency matrix A.

$${\sum }_{j = 1}^{n} \{ R ( {A}_{i , \text{:}} ) + R ( {A}_{\text{:} , i} ) \} \qquad [ Equation 6 ]$$

In Equation 6, A_{i,:} and A_{:,j} denote the i^{th} row and the i^{th} column of the adjacency matrix A, respectively. In Equation 6, R(⋅) is defined as Equation 7 below.

$$R ( a ) = {( {\sum }_{i = 1}^{n} {\vert {a}_{i} \vert}^{p} )}^{\frac{1}{p}} \qquad [ Equation 7 ]$$

In Equation 7, p may be set to a value smaller than one, that is, p<1. The above-described normalization term has an effect of inducing the values of some elements of a vector a to be large and the values of the other elements to be small. Setting such a regularization term is effective in deriving the relationship of only directly related nodes.

Each process of training the second neural network will be described with reference to FIG. 4 again.

The generated data input unit 143 prepares training data and delivers the training data to the generation evaluation unit 144.

The training data of the generated data input unit 143 includes only data corresponding to the input value xᵢ of the predicted data input unit 141. The generated data input unit 143 chooses data separately from the predicted data input unit 141 and delivers the chosen data to the generation evaluation unit 144.

In an embodiment, the training data of the generated data input unit 143 may include data having the same configuration as the input data of the predicted data input unit 141 and is separately denoted by xⱼ for convenience of description.

In another embodiment, the input value xⱼ of the generated data input unit 143 may include an input value that is input to the input layer of the first neural network and an input value that satisfies a predetermined situation condition. That is, the training unit 140 aims to compare actual data xⱼ to an intermediate point value \tilde{x}ᵢ^{l} generated by the generation unit 130, which will be described below, and generate training information so that the prediction unit 120 and the generation unit 130 can generate an intermediate point value having characteristics similar to those of the actual data. Accordingly, the generated data input unit 143 may choose, as an input value xⱼ, data measured in a situation condition similar to a situation condition in which xᵢ chosen by the predicted data input unit 141 is measured. For example, the road traffic network as shown in FIG. 3 is configured as follows.

First, data observed at a time similar to when xᵢ is observed is chosen as xⱼ. For example, when xᵢ is data measured for the commuting hour, the generated data input unit 143 may choose commuting hour data on another day as xⱼ.

Alternatively, data observed under situation conditions in which the day of the week, season, and weather are similar to those in which xᵢ is observed may be chosen as xⱼ.

As another example, when there was a traffic accident at the time of measuring xᵢ, data measured at the time of the traffic accident may be selected as xⱼ.

In this way, the input value xᵢ for the prediction unit 120 and the input value xⱼ for the generation unit 130 may have the same input value or an input value that satisfies a predetermined situation condition (e.g., time, weather, event, etc.).

The generation unit 130 receives an intermediate value Hᵢ^{l} in the l^{th} hidden layer of the first neural network, which is based on the graph neural network, from the second neural network, which is based on a deep neural network, and calculates an intermediate point value \tilde{x}ᵢ^{l} between a point at which an input value is observed and a point at which a target value is observed. In this case, the intermediate point value \tilde{x}ᵢ^{l} corresponds to n-dimensional data having the same form as the input value xⱼ.

The generation evaluation unit 144 distinguishes or classifies the input value xⱼ, which is data actually observed and collected, and the intermediate time value \tilde{x}ᵢ^{l}, which is generated by the generation unit 130. That is, the generation evaluation unit 144 evaluates how similar the generated data is to the actual data on the basis of the output of the hidden layer.

Specifically, the generation evaluation unit 144 aims to generate second training information such that the hidden layer 122 of the graph neural network of the prediction unit 120 and the deep neural network of the generation unit 130 can generate an intermediate point value \tilde{x}ᵢ^{l} having similar characteristics to actually measured data xⱼ.

This does not mean measuring how precisely individual element values of the intermediate point value \tilde{x}ᵢ^{l} and the input value xⱼ match each other, just as the prediction evaluation unit 142 calculates an error between the target value yᵢ and the predicted value \tilde{y}ᵢ. Likewise, this does not mean measuring how precisely individual element values of the target value yᵢ and the intermediate point value \tilde{x}ᵢ^{l} match each other. That is, the generation evaluation unit 144 aims to evaluate how similar the distribution or characteristics of the intermediate point value \tilde{x}ᵢ^{l} are to the actually measured data xⱼ.

A method of the generation evaluation unit 144 evaluating how similar the intermediate point value \tilde{x}ᵢ^{l} is to the actual data xⱼ on the basis of the output of the hidden layer 122 of the graph neural network will be described in detail as follows.

When receiving the input value xⱼ and the intermediate point value \tilde{x}ᵢ^{l}, the generation evaluation unit 144 distinguishes the input value xⱼ and the intermediate point value \tilde{x}ᵢ^{l}. In an embodiment, the generation evaluation unit 144 may generate second training information that allows a first identifier to be output when the input value xⱼ is received and allows a second identifier different from the first identifier to be output when the intermediate point value \tilde{x}ᵢ^{l} is received. For example, the first identifier may be +1, and the second identifier may be −1. That is, the generation evaluation unit 144 is configured to distinguish the input value xⱼ and the intermediate point value \tilde{x}ᵢ^{l} generated by the learned adjacency matrix A and generates information on how similar the data \tilde{x}ᵢ^{l} generated by the learned causality is to the input value xⱼ or how easily the data \tilde{x}ᵢ^{l} generated by the learned causality is distinguished from the input value xⱼ. To this end, the generation evaluation unit 144 may include a binary classifier.

On the contrary, when the generation evaluation unit 144 receives an intermediate point value \tilde{x}ᵢ^{l}, the second neural network of the generation unit 130 may calculate an intermediate point value \tilde{x}ᵢ^{l} that allows the first identifier to be output. In other words, the generation unit 130 may generate an intermediate point value \tilde{x}ᵢ^{l} similar to the input value xⱼ so that it is difficult for the generation evaluation unit 144 to distinguish the input value xⱼ and the intermediate point value \tilde{x}ᵢ^{l}.

FIG. 5 illustrates a flow of first training information and second training information generated by the prediction evaluation unit 142 and the generation evaluation unit 144. The prediction evaluation unit 142 may set first training information as an input of the output layer 123 of the first neural network, deliver the first training information to the hidden layer 122 and the input layer 121, and train the first neural network. Also, the generation evaluation unit 144 may input second training information to at least one of the hidden layer 122 and the input layer 121 of the first neural network and train the first neural network.

Thus, the first neural network, which is a graph neural network, is trained to accurately predict the target value yᵢ. In addition, the first neural network is trained to generate the intermediate point value \tilde{x}ᵢ^{l}, which is between the input value xᵢ and the output value yᵢ, that is similar to actual data well.

This is not just to train the graph neural network to accurately predict an output value for an input but to induce the deep neural network to learn a principle in which actual data is generated by interactions between nodes. As a result, this is to induce the adjacency matrix A, which expresses actual relationships between nodes, to be well derived.

The reason for training and applying the second neural network to learn the adjacency matrix A, which expresses relationships between nodes, will be described in more detail as follows. Deep neural networks are well known for easily overfitting even very complex data. Therefore, when the graph neural network is trained using only the first training information calculated by the prediction evaluation unit 142, the graph neural network is trained so that a predicted value and a target value match each other, regardless of a principle in which data is generated by interactions between nodes. Accordingly, when only the first training information computed by the prediction evaluation unit 142 is used, it is not possible to acquire an adjacency matrix A that reflects the principle of generating actual data well. In order to solve this problem, according to an embodiment of the present invention, it is possible to acquire an adjacency matrix A that can better reflect causality between input variables by training the graph neural network using second training information derived through a separate deep neural network.

Meanwhile, a process of calculating the first and second training information and training first and second neural networks on the basis of the first and second training information may be repeated a preset maximum number of training times, which may be set through the above-described policy unit 150. When the preset maximum number is exceeded, the training unit 140 ends the training, and the output unit 160 outputs or stores a result of the training.

For reference, the elements illustrated in FIGS. 1 and 7 according to embodiments of the present invention may be implemented as software or hardware such as a field-programmable gate array (FPGA) or an application-specific integrated circuit (ASIC) and may perform predetermined roles.

However, the elements are not limited to software or hardware and may be configured to be in an addressable storage medium or configured to activate one or more processors.

Accordingly, as an example, the elements include elements such as software elements, object-oriented software elements, class elements, and task elements, processes, functions, attributes, procedures, subroutines, program code segments, drivers, firmware, microcode, circuits, data, database, data structures, tables, arrays, and variables.

Elements and functions provided by corresponding elements may be combined into a smaller number of elements or may be divided into additional elements.

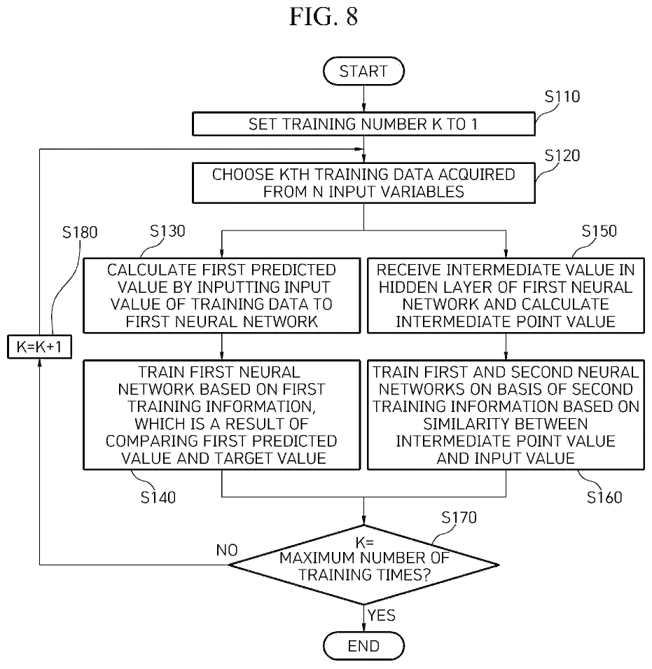

FIG. 8 is a flowchart of a deep neural network training method according to an embodiment of the present invention.

Meanwhile, it may be understood that operations illustrated in FIG. 8 are performed by a server included in a deep neural network-based system (hereinafter referred to as a server) 100, but the present invention is not limited thereto.

First, the server sets a training number k to 1 (S110) and selects k^{th} training data acquired from n input variables (here n is a natural number greater than or equal to 2) (S120).

Subsequently, the server inputs an input value to an input layer of a first neural network, which is based on a graph neural network, and calculates a predicted value through an output layer (S130) and trains the first neural network on the basis of first training information, which is a result of comparing the predicted value and a target value of the training data (S140).

Subsequently, the server receives an intermediate value in an l^{th} hidden layer (here l is a natural number greater than or equal to 1) of the first neural network from a second neural network, which is based on a deep neural network, and calculates an intermediate point value between a point at which the input value is observed and a point at which the target value is observed (S150). Then, the server trains the first and second neural networks on the basis of second training information based on similarity between the intermediate point value and the input value of the training data (S160).

The server repeatedly trains the first and second neural networks a preset maximum number of training times (S170, S180) and provides the finally trained first and second neural networks as an output result or provides an adjacency matrix of the trained first neural network as an output result.

In this case, the adjacency matrix is characterized by having a size corresponding to the square of the number (n) of input variables and an element value with causality between 0 and 1, which is relatively expressed according to the strength of the causality relationship between the input variables.

Meanwhile, in the above description, operations S110 to S180 may be divided into sub-operations or combined into a smaller number of operations depending on the implementation of the present invention. Also, if necessary, some of the operations may be omitted, or the operations may be performed in an order different from that described above. Furthermore, although not described here, the above description with reference to FIGS. 1 to 7 may apply to the deep neural network training method of FIG. 8.

The above-described deep neural network training method according to an embodiment of the present invention may be implemented as a program (or application) that can be executed in combination with a computer, which is hardware, and the program may be stored in a medium.

In order for the computer to read the program and execute the method implemented with the program, the program may include code of a computer language such as C, C++, JAVA, and machine code which can be read by a processor (central processing unit (CPU)) of the computer through a device interface of the computer. Such code may include functional code associated with a function defining functions necessary to execute the methods and the like and may include control code associated with an execution procedure necessary for the processor of the computer to execute the functions according to a predetermined procedure. Also, such code may further include memory reference-related code indicating a position (an address number) of a memory inside or outside the computer at which additional information or media required for the processor of the computer to execute the functions should be referenced. Further, in order for the processor of the computer to execute the functions, when the processor needs to communicate with any other computers or servers, etc. at a remote location, the code may further include communication-related code indicating how the processor of the computer communicates with any other computers or servers at a remote location using a communication module of the computer, what information or media the processor of the computer transmits or receives upon communication, and the like.

The storage medium refers not to a medium that temporarily stores data, such as a register, a cache, and a memory but to a medium that semi-permanently stores data and that is readable by a device. In detail, examples of the storage medium include read-only memory (ROM), random-access memory (RAM), CD-ROMs, magnetic tapes, floppy disks, optical data storage devices, etc., but the present invention is not limited thereto. That is, the program may be stored in various recording media on various servers accessible by the computer or in various recording media on a user's computer. Also, the medium can also be distributed over network-coupled computer systems so that the computer-readable code is stored in a distributed fashion.

The steps of a method or algorithm described in connection with an embodiment of the present invention may be embodied directly in hardware, in a software module executed by hardware, or a combination of the two. A software mode may reside in random access memory (RAM), read-only memory (ROM), erasable programmable ROM (EPROM), electrically erasable programmable ROM (EEPROM), flash memory, a hard disk, a removable disk, a CD-ROM, or any form of storage medium that is known in the art.

In the case of the Granger causality relationship analysis, which is widely used for causality relationship analysis on time series data, it is difficult to analyze causality relationships when a linear method is used and there are many variables. However, according to an embodiment of the present invention, it is possible to easily detect input variables that are in a non-linear causality relationship using graph neural network technology.

Also, in the case of a graph neural network, a user should directly input a relationship between input variables. However, according to the present invention, it is advantageously possible to train and generate a graph neural network by automatically deriving a causality relationship from training data even if a user does not directly input the relationship between input variables.

In addition, in the case of a deep neural network, although its prediction and recognition performance is excellent, it is often difficult to interpret an inference result. However, according to the present invention, by automatically extracting a causality relationship between input variables, it is advantageously possible to interpret a training result of the deep neural network.

Advantageous effects of the present invention are not limited to the aforementioned effects, and other effects which are not mentioned here can be clearly understood by those skilled in the art from the following description.

Although embodiments of the present invention have been described with reference to the accompanying drawings, those skilled in the art will appreciate that various modifications and alterations may be made therein without departing from the technical spirit or essential feature of the present invention. Therefore, it should be understood that the above embodiments are illustrative rather than restrictive in all respects.

What is claimed is:

1. A deep neural network training method for detecting causality between input values, which is performed by a computer including a memory and a processor, the deep neural network training method comprising operations of:
inputting an input value of training data acquired from n input variables (n is a natural number greater than or equal to 2) to an input layer of a first neural network and calculating a predicted value through an output layer;
training the first neural network on the basis of first training information, which is a result of comparing the predicted value to a target value of the training data;
receiving an intermediate value in an l^{th} hidden layer (l is a natural number greater than or equal to 1) of the first neural network from a second neural network, which is based on a deep neural network, and calculating an intermediate point value between a point at which the input value is observed and a point at which the target value is observed; and
training the first and second neural networks on the basis of second training information based on similarity between the intermediate point value and the input value of the training data.

2. The deep neural network training method of claim 1, wherein the training data comprises an input value observed at time t and a target value observed at time t+1 which is immediately after time t.

3. The deep neural network training method of claim 1, wherein the operation of inputting an input value of training data acquired from n input variables to an input layer of a first neural network, which is based on a graph neural network, and calculating a predicted value through an output layer comprises:
inputting n input values obtained from the n input variables to the input layer of the graph neural network; and
calculating n predicted values corresponding to the n input values and outputting the predicted values through the output layer.

4. The deep neural network training method of claim 1, wherein the operation of training the first neural network on the basis of first training information, which is a result of comparing the predicted value to a target value of the training data, comprises generating the first training information on the basis of an error between the predicted value and the target value.

5. The deep neural network training method of claim 1, wherein the operation of training the first neural network on the basis of first training information, which is a result of comparing the predicted value to a target value of the training data, comprises setting the first training information as an input of the output layer of the first neural network, delivering the first training information to a hidden layer and the input layer, and training the first neural network.

6. The deep neural network training method of claim 1, further comprising an operation of calculating the intermediate value in the l^{th} hidden layer on the basis of an activation function in the l^{th} hidden layer of the first neural network,
wherein the activation function comprises an adjacency matrix containing causality between the n input variables, model parameters, and an intermediate value in an (l−1)^{th} hidden layer.

7. The deep neural network training method of claim 6, further comprising an operation of constructing the adjacency matrix from the n input variables,
wherein the adjacency matrix has a size corresponding to the square of the number (n) of input variables and contains an element value with causality between 0 and 1, which is relatively expressed according to the strength of causality relationships between the input variables.

8. The deep neural network training method of claim 7, wherein the operation of constructing the adjacency matrix from the n input variables comprises:
calculating each element value of an initial adjacency matrix having the same size as the adjacency matrix;
generating a first diagonal matrix obtained by summing element values in each row of the initial adjacency matrix and a second diagonal matrix obtained by summing element values in each column; and
calculating the adjacency matrix on the basis of a multiplication operation between the initial adjacency matrix and an inverse square root matrix corresponding to the calculated first and second diagonal matrices.

9. The deep neural network training method of claim 7, wherein the operation of constructing the adjacency matrix from the n input variables further comprises setting, in the adjacency matrix, a regulation term that targets each row and each column of the adjacency matrix to increase deviation between the element values included in the adjacency matrix.

10. The deep neural network training method of claim 6, wherein in the operation of training the first and second neural networks on the basis of second training information based on similarity between the intermediate point value and the input value of the training data, the second neural network is trained based on the second training information which allows a first identifier to be output when the input value is received and allows a second identifier different from the first identifier to be output when the intermediate point value is received.

11. The deep neural network training method of claim 10, wherein in the operation of receiving an intermediate value in an l^{th} hidden layer of the first neural network from a second neural network, which is based on a deep neural network, and calculating an intermediate point value between a point at which the input value is observed and a point at which the target value is observed, the second neural network calculates the intermediate point value which allows the first identifier to be output when the intermediate point value for training the second neural network is received in the operation of training the first and second neural networks.

12. The deep neural network training method of claim 10, wherein the operation of training the first and second neural networks on the basis of second training information based on similarity between the intermediate point value and the input value of the training data comprises training the first neural network by inputting the generated second training information to at least one of the hidden layer and the input layer of the first neural network.

13. The deep neural network training method of claim 10, wherein in the operation of training the first and second neural networks on the basis of second training information based on similarity between the intermediate point value and the input value of the training data, the second training information is calculated based on similarity between the intermediate point value and an input value that is the same as the input value input to the input layer of the first neural network or an input value that satisfies a predetermined situation condition.

14. The deep neural network training method of claim 10, wherein the operation of training the first and second neural networks on the basis of second training information based on similarity between the intermediate point value and the input value of the training data is repeated a preset maximum number of training times to train the first and second neural networks.

15. A method of detecting causality between input variables using a deep neural network, which is performed by a computer including a memory and a processor, the method comprising operations of:
inputting an input value of training data acquired from n input variables (n is a natural number greater than or equal to 2) to an input layer of a first neural network, which is based on a graph neural network, and calculating a predicted value through an output layer;
training the first neural network on the basis of first training information, which is a result of comparing the predicted value to a target value of the training data;
receiving an intermediate value in an l^{th} hidden layer (l is a natural number greater than or equal to 1) of the first neural network from a second neural network, which is based on a deep neural network, and calculating an intermediate point value between a point at which the input value is observed and a point at which the target value is observed;
training the first and second neural networks on the basis of second training information based on similarity between the intermediate point value and the input value of the training data; and
repeatedly training the first and second neural networks a preset maximum number of training times; and
providing an adjacency matrix of the trained first neural network,
wherein the adjacency matrix has a size corresponding to the square of the number (n) of input variables and has an element value with causality between 0 and 1, which is expressed relatively according to the strength of causality relationships between the input variables.

16. A deep neural network-based system for detecting causality between input values, the deep neural network-based system comprising:
a memory in which a program for detecting the causality between the input values on the basis of training data acquired from n input variables (n is a natural number greater than or equal to 2) is stored; and
a processor configured to execute the program stored in the memory, wherein when the program is executed,
the processor inputs an input value of training data to an input layer of a first neural network, which is based on a graph neural network, calculates a predicted value through an output layer, and trains the first neural network on the basis of first training information, which is a result of comparing the predicted value to a target value of the training data, and
the processor receives an intermediate value in an l^{th} hidden layer (l is a natural number greater than or equal to 1) of the first neural network from a second neural network, which is based on a deep neural network, calculates an intermediate point value between a point at which the input value is observed and a point at which the target value is observed, and trains the first and second neural networks on the basis of second training information based on similarity between the intermediate point value and the input value of the training data.

17. The deep neural network-based system of claim 16, wherein the processor generates the first training information on the basis of an error between the predicted value and the target value, sets the first training information as an input of the output layer of the first neural network, delivers the first training information to a hidden layer and the input layer, and trains the first neural network.

18. The deep neural network-based system of claim 16, wherein
the processor calculates the intermediate value in the l^{th} hidden layer on the basis of an activation function in the l^{th} hidden layer of the first neural network, and
the activation function comprises an adjacency matrix containing causality between the n input variables, model parameters, and an intermediate value in an (l−1)^{th} hidden layer.

19. The deep neural network-based system of claim 16, wherein the processor calculates each element value of an initial adjacency matrix having the same size as the adjacency matrix, generates a first diagonal matrix obtained by summing element values in each row of the initial adjacency matrix and a second diagonal matrix obtained by summing element values in each column, and calculates the adjacency matrix on the basis of a multiplication operation between the initial adjacency matrix and the calculated first and second diagonal matrices.

20. The deep neural network-based system of claim 16, wherein the processor trains the second neural network on the basis of the second training information which allows a first identifier to be output when the input value is received and allows a second identifier different from the first identifier to be output when the intermediate point value is received, and calculates the intermediate point value which allows the first identifier to be output when the second neural network receives the intermediate point value.
